(19) United States
(12) Patent Application Publication
(10) Pub. No.: US 2003/0056466 A1
(43) Pub. Date: Mar. 27, 2003

(54) Solution filling and plugging system to a container

(76) Inventor: Shigenori Muneyasu, Kawachinagano (JP)

Correspondence Address: WENDEROTH, LIND & PONACK, L.L.P., 2033 K STREET N. W., SUITE 800, WASHINGTON, DC, 20006-1021, US

(21) Appl. No.: 10/251,808

(22) Filed: Sep. 23, 2002

(30) Foreign Application Priority Data
Sep. 27, 2001 (JP) 2001-296644

(51) Int. Cl. B65B 7/28; B65B 43/42; B67C 3/00

(52) U.S. Cl. 53/75; 141/171

(57) ABSTRACT

The objective of the present invention is to provide a solution filling and plugging system to a container capable of shortening the overall length of the transporting and filling line, and coping with containers in a variety of shapes with a change only to the chuck retaining the container.

And, it comprises at least container aligning and feed process A, solutions filling process B and plugging process C, performs delivery of containers K between the respective processes with a robots R1˜R11 disposed between the respective processes and controls the posture of the robots R1˜R11 for retaining and delivering the containers K, by means of programmed control according to the shape, etc. of the containers K, so as to carry the containers K one after another without being influenced by the container shape.

### BACKGROUND OF THE INVENTION

The present invention relates to a solution filling and plugging system to a container, more specifically a solution filling and plugging system to a container capable of automatically filling fillers such as solutions, etc. into containers of a variety of shapes, by keeping the internal volume of a clean room as small as possible without changing the conveying and filling line, nor being influenced by either the shape or the size (hereinafter referred to as “shape, etc.”) of the containers.

Conventionally, when filling a filler such as liquid solutions, etc. into containers such as bottle, synthetic resin container, etc. hereinafter referred to as “containers”), a normal practice is that (a filling and plugging system) is constructed, in a sterilized clean room, in a way to connect between the respective processes such as container aligning process, solutions filling process, plugging process, etc. with a special carrying means such as conveyor, for example, adapted to conveyance of the containers, or constructed by disposing said respective filling processes along a special conveyor adapted to conveyance of the containers, so as to continuously and automatically fill solutions and plug (the containers) in a sterilized atmosphere.

By the way, with said conventional solution filling and plugging system to a container, which is constructed in a way to connect between the respective processes disposed for filling solutions with a carrying means such as conveyor, etc. conveying containers along the sequence of the processes, the overall length of such filling system was rather long and this inevitably led to a large volume of the clean room in which is disposed this system, presenting a problem of a high equipment cost.

Moreover, the shape, etc. of containers in which to fill the solutions, etc. is not uniform, as shown in FIG. 6, and this makes it necessary to provide special carrying means, filling means, plugging means, etc. adapted to the types of containers to be conveyed, for carrying containers of various shapes, because it is difficult to treat them on a single line. In addition, since special lines adapted to different containers are disposed in each clean room, the total volume of the clean room becomes large, and the equipment cost also increases. For those reasons, there was a problem that such conventional system is not suitable to a filling plant making multikind small-lot production by switching containers different in shape, etc. to one another for respective predetermined quantities.

Furthermore, in the case where the carrying and filling is changed according to the shape, etc. of the container each time when containers of different shape, etc. are used, it takes much time for switching the lines, presenting a problem of drop of production efficiency because the carrying and filling line stops during the switching of lines.

### SUMMARY OF THE INVENTION

The objective of the present invention, realized in view of said problems with conventional filling systems, is to provide a solution filling and plugging system to a container capable of shortening the overall length of the carrying and filling line, and coping with containers of a variety of shapes by changing only the chuck retaining the container.

To achieve said objective, the solution filling and plugging system to container according to the present invention is a solution filling and plugging system to a container characterized in that it at least comprises a container aligning and feed process, a solution filling and plugging process, performs delivery of containers between the respective processes using a robot disposed between the respective processes, and controls the posture of the robot for retaining and delivering the containers by means of a programmed control according to the shape, etc. of the containers, so as to carry the containers one after another without being influenced by container shape.

According to the solution filling and plugging system to a container of the present invention, realized in such a way as to perform conveyance and delivery of containers between the container alignment and feed process, the solution filling and plugging process with a robot respectively, can easily and quickly be switched into conveyed containers and filling lines suitable to containers of a variety of shapes, by merely changing the software of the program controlling the robots, without making any change to the conveying and filling line itself, and can also shorten the overall length of the conveying and filling line, thus enabling a reduction in volume of the clean room compared with the conventional method, and to remarkably reduce construction and maintenance costs of the facilities where this system is introduced.

Moreover, this system, designed to carry out the conveyance of containers between respective processes with a robot and by controlling its delivering posture, can be realized as a flexible system with a wide range of applications, adaptable to containers of a variety of shapes and capable of performing proper delivery and conveyance of containers without being influenced by container shape.

In this case, an articulated robot may be used.

This makes it possible to easily control the delivery of containers between the respective processes in a posture adapted to the work of the subsequent process.

Furthermore, a chuck retaining the container depending on its shape may be replaceably disposed on the robot.

This makes it possible to change (a conveying and filling line) to a line adapted to a variety of shapes, without making any major changes in the line, by simply replacing the chuck with another one, even when the shape of container, etc. has changed, to perform delivery and conveyance of proper containers without being influenced by container shape.

Still more, for the solution filling process, the container holding posture can be controlled so that the container may take an optimal posture against the filling nozzle.

This makes the easy filling of solutions possible, without producing foam or being influenced by container shape, and highly accurate filling can be automatically performed without the mixing in of impurities, even in the case of a solution solution which is liable to foam easily.

Yet more, between the container aligning and feed process and the solution filling process, the system may be provided with a container direction change process for detecting the direction of containers and forcing them to travel in a unified direction.

This makes it possible to perform the subsequent operation in the process correctly with high accuracy by preventing errors, even with containers which are asymmetric either in shape or on their face.

Moreover, a container cleaning process may be provided before the solution filling process.

This makes it possible to perform filling without the mixing in of impurities in clean containers, by recovering a high degree of cleanliness, even if there was contamination, etc. in the previous process.

Furthermore, in the container cleaning process, the container holding posture can be controlled so that the container may take an optimal posture against the cleaning nozzle.

This makes it possible to clean every comer of the container and recover a high degree of cleanliness, without being influenced by container shape.

Still more, between the solution filling and plugging processes, an inner cap plugging process for forcing inner caps to travel in a unified direction may be provided.

This makes it possible to apply (a solutions filling and plugging system) without difficulty, even to containers having an inner cap, especially in a case where the inner cap has directivity, and forces inner caps to travel in a unified direction easy.

### BRIEF DESCRIPTION OF THE DRAWINGS

FIG. 1 is a schematic plan view showing an embodiment of the solution filling and plugging system to a container according to the present invention.

FIG. 2 is a plan view showing details from the aligning and feed process of containers to the cleaning process.

FIG. 3 is a plan view showing details from the cleaning process to the solutions filling process.

FIG. 4 is a plan view showing details from the inner cap plugging process to the plugging process.

FIG. 5 indicates releasing actions by chuck of the robot, (a) being a perspective view before the releasing action, and (b) a perspective view during the releasing action.

FIG. 6 is a plan view showing containers of different shapes.

FIG. 7 is an action explanatory drawing of a container during cleaning.

FIG. 8 is an action explanatory drawing of a container during filling.

### DETAILED DESCRIPTION OF THE INVENTION

An embodiment of the solution filling and plugging system to a container according to the present invention will be explained below based on drawings.

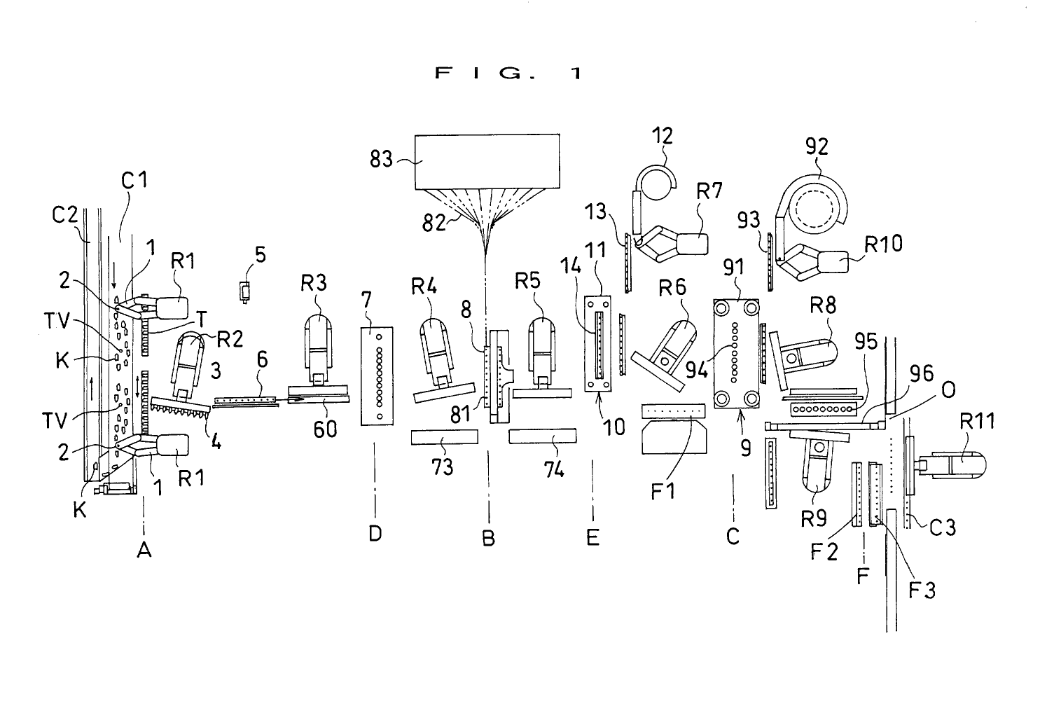

FIG. 1˜FIG. 8 indicate an embodiment of the solution filling and plugging system to a container according to the present invention.

The present invention is constructed by disposing a container aligning and feed process A for receiving empty containers, conveyed side by side at random on an empty container feed conveyor, from the conveyor and aligning them on an empty container aligning tray to facilitate conveyance by robot, a solutions filling process B for filling prescribed solutions in these aligned containers, and a plugging process C for plugging (with cap) the containers filled with solutions, sequentially along the conveying and filling line, performing the delivery of containers between the respective processes A, B, C with synchronized drive of a plurality of units of dust-free articulated robot, and controlling the robots with program according to the container shape, etc., so as to convey the containers without being influenced by the container shape, while controlling the holding and delivering postures of the aligned containers.

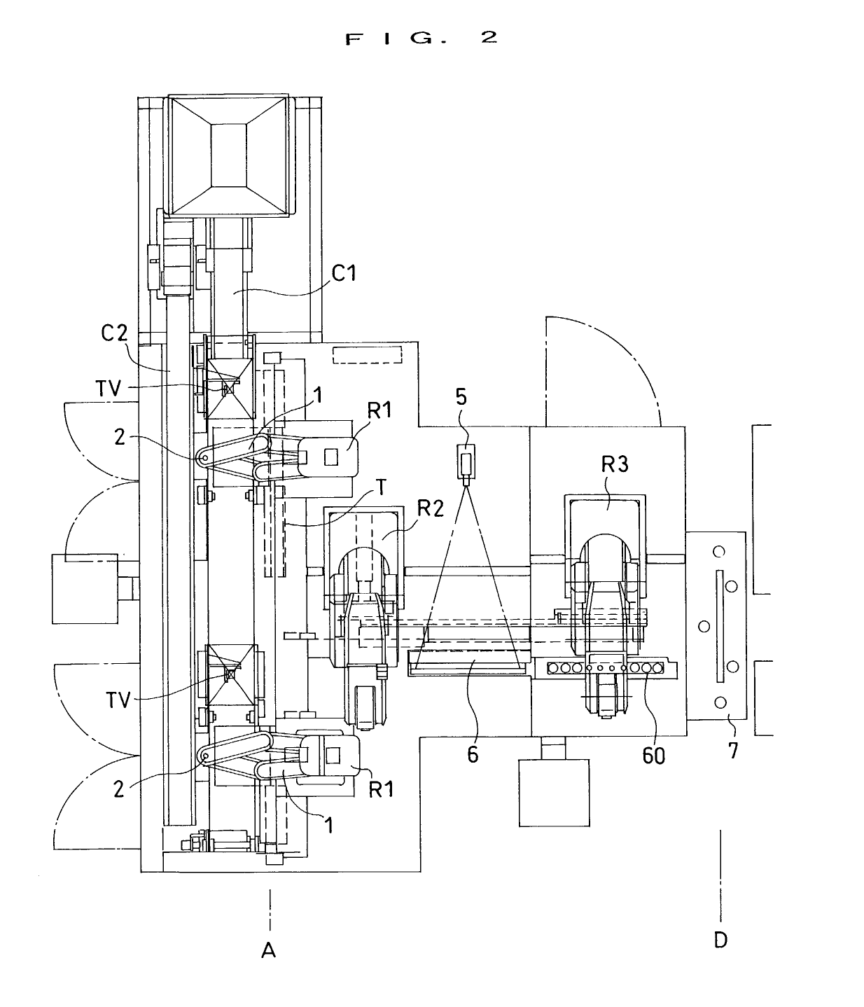

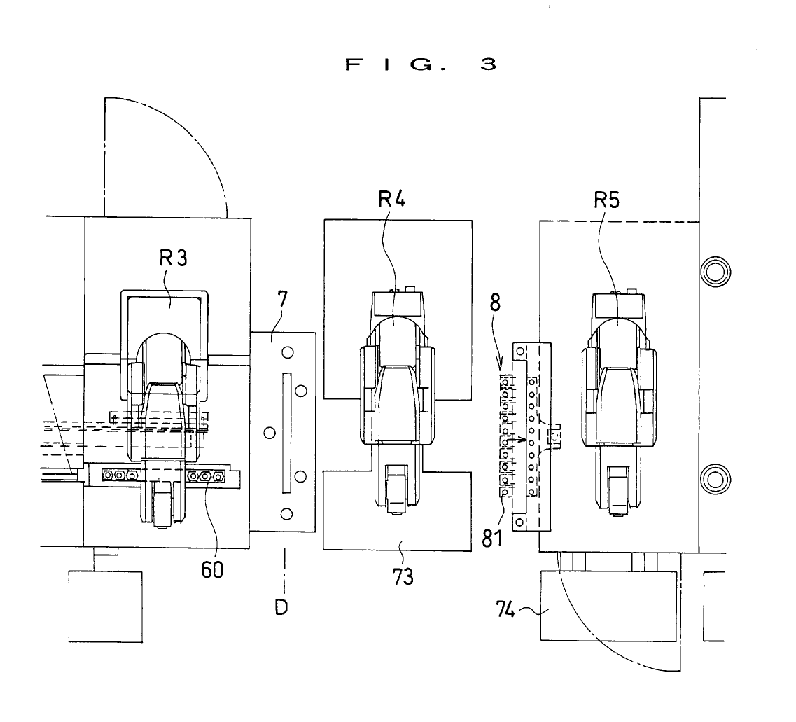

The container aligning and feed process A, though not particularly restricted, is realized in a way to convey empty containers K by placing them at random with the use of a conveying means such as empty container feed conveyor C1, for example, adsorb them one after another with an adsorbing pad, transfer them to the tray side, and return the empty containers left on the empty container feed conveyor C1 by this robot R1 on a return conveyor C2, as shown in FIG. 2, for example.

Moreover, (this container aligning and feed process A) is so constructed as to fetch images of the conveyed containers K, by means of a television camera TV disposed above the empty container feed conveyor (C1), and dispose the empty container intake robot R1, controlled and driven by the signal of the fetched images, along the empty container feed conveyor C1, so as to fetch the containers K conveyed at random on the empty container feed conveyor C1 with this empty container intake robot R1, and align and dispose them one after another on the empty container aligning tray T disposed along the empty container feed conveyor C1.

This television camera TV and the empty container intake robot R1 are paired, and one or no less than 2 pairs of them depending on the system capacity are disposed along the empty container feed conveyor C1.

This empty container intake robot R1 fetches the containers K by adsorbing them one by one, in linkage with the fetched images of the containers K conveyed by the television camera TV, by means of the adsorbing pad (sucker) 2 mounted at the tip of an arm 1 which makes complicated movements combining bending, expansion & contraction, slewing, etc., and place and arrange them on the empty container aligning tray T from above the empty container feed conveyor (C1). On this empty container aligning tray T are aligned a set number of empty containers or 10 pieces, for example, with the mouth up.

As the set number of empty containers are placed in order on the empty container aligning tray T, (the container aligning and feed process A) receives the empty containers from the empty container aligning tray T by means of a container transfer robot R2. This robot R2 is equipped, replaceably, with a chuck 3, for making complicated movements combining bending, expansion & contraction, slewing, etc., and receives the empty containers arranged on the tray in a way to hold them with this chuck 3. This chuck 3 of the robot R2 is provided with chucking claws 4 designed to hold all the empty containers disposed on the empty container aligning tray T at a time. In this embodiment, it can hold 10 pieces of empty container at a time.

Furthermore, while the empty containers held by this chuck 3 of the robot R2 are sent to the subsequent filling process B, there are cases where the empty containers are made to pass through a cleaning process D, when it is necessary to clean the inside of the aligned empty containers, before sending them directly to the filling process B, to prevent mixing of impurities during the filling of solution solution.

To prevent mixing of impurities during this filling of solution solution, the empty containers held by the robot R2 are cleaned, in the next step, by injecting clean air in the empty containers and, as required, by suction, and then delivered to the cleaning process D for eliminating impurities. In that case, if the containers have a distinction between surface and back face as difference in shape on surface and back face, etc., the empty containers held by the robot R2 may be transferred to a container holder 60 disposed on an direction control device 6, to align the direction of all empty containers by slewing only the empty containers the direction of which is different, based on the inspection data obtained by inspecting empty containers with an inspecting means 5 such as camera, etc. To perform this inspection with inspecting means 5 such as camera, etc. accurately and easily, this direction control device 6 is designed in a way to support the aligned respective empty containers with a slewable container holder 60 and, after the inspection, move this container holder 60 to the place of delivery i.e. in front of the delivery robot R3 on the direction control device 6, so as to hold only empty containers from the container holder 60 on the chuck 3 of the robot R3, for transfer.

For improving accuracy of this inspection, there are cases where irradiation of light is made, from back face side, on the empty containers placed on the direction control device 6 and held and aligned in the container holder 60.

The delivery of empty containers from direction control device 6 to robot R3 is made by moving the container holder 60 on the direction control device 6 to the space in front of the delivery robot R3, and all the empty containers held by this chuck (3) of the robot R3 are delivered to the cleaning process D. The delivery robot R3, which makes delivery between the direction control device 6 and the cleaning device 7, is constructed in the same way as the robot R2, so as to perform delivery of empty containers between processes, by swinging and slewing the chuck 3 with general swinging within the respective allowable angles of the robot body and the chuck.

The cleaning device 7 constituting the cleaning process D is held, though not particularly restricted, by the chuck 3 of the robot R2 and the robot R3, and is disposed in the direction crossing the direction of conveyance of the aligned empty containers to be delivered, to shorten the conveying & filling line and reduce the volume of the clean room. This shall also apply to the solutions filling process B, the inner cap plugging process E and the plugging process C to be described later.

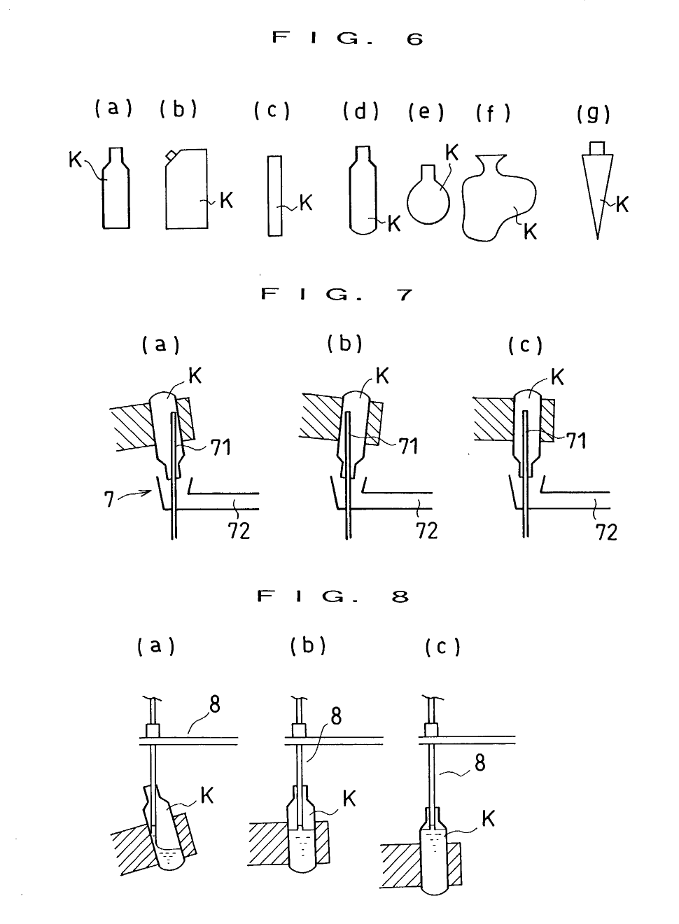

This cleaning device 7 is composed of a cleaning nozzle 71 for injecting clean air in the empty containers held by the chuck 3 of the robot R3, and an exhaust duct 72 for leading the air discharged through the empty containers to the outside of the clean room. With this construction, the empty containers held by the chuck 3 with the mouth down are moved by the robot R3 to a position over the cleaning nozzle 71 protruding upward, to insert the cleaning nozzle 71 in the empty containers by lowering the chuck 3, and swing the empty containers held by the chuck 3 while injecting clean air from the cleaning nozzle 71, as shown in FIG. 7.

By so doing, it becomes possible for the clean air to get to various parts inside the container from different angles, on the inner side faces of the container, and to clean every comer of the container to remove impurities sticking to the inner side faces and comers of the container. And, this exhaust duct 72, designed to suck with vacuum or (negative) pressure, the impurities discharged from inside the container are sucked into the exhaust duct (72) together with the air after cleaning, and discharged to the outside of the clean room.

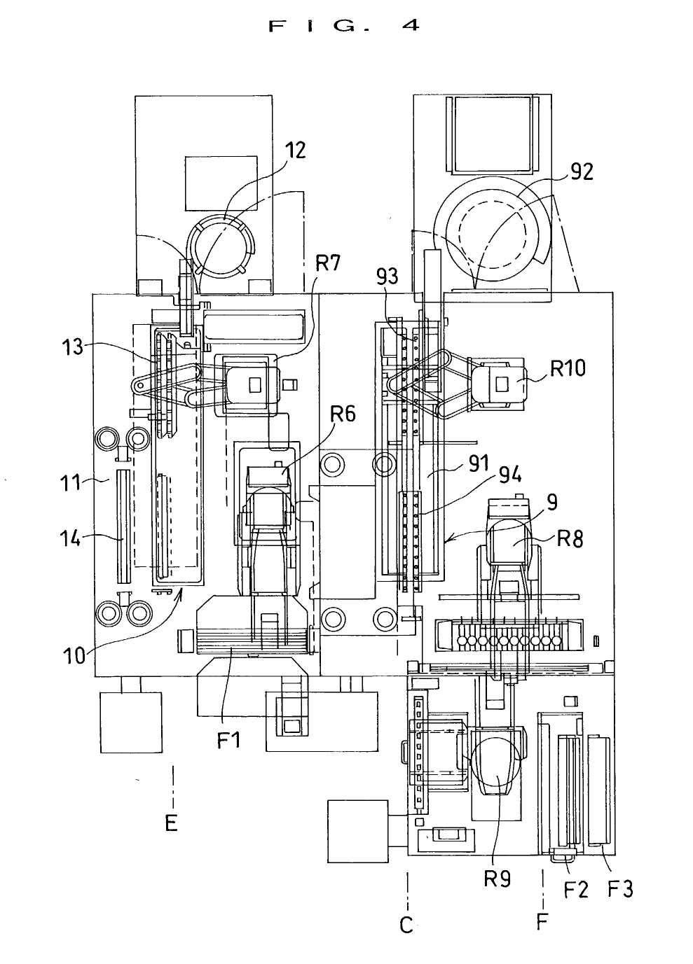

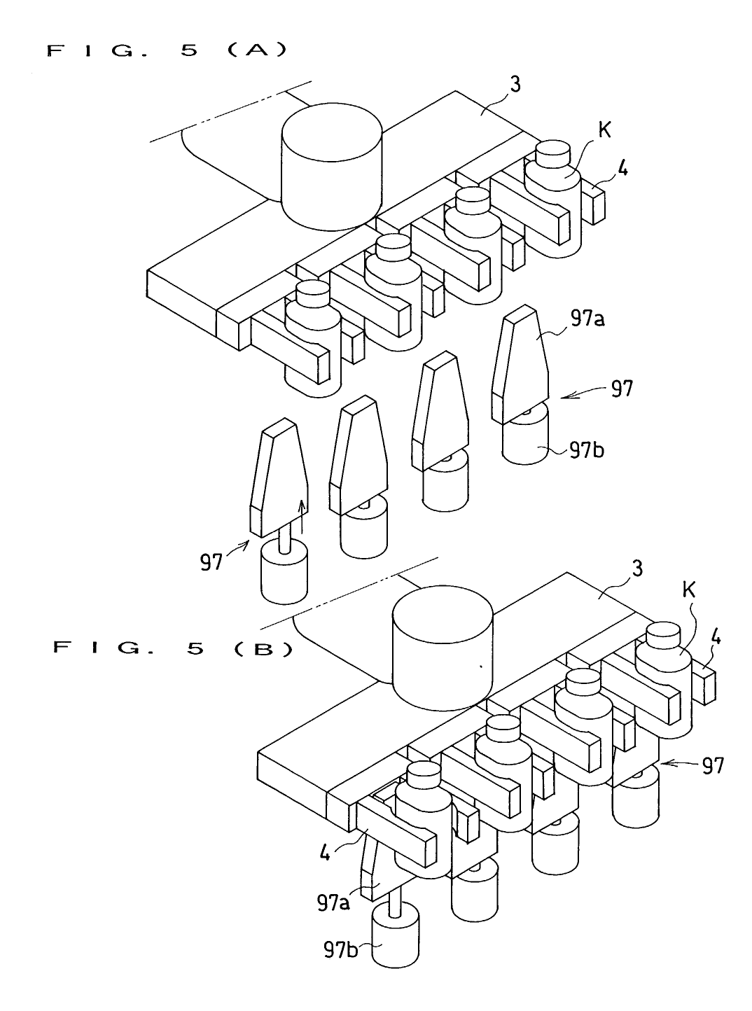

The holding of empty containers by the chuck 3 of the robot R3 is made by pinching the containers at the shell part with the chucking claws 4 of the chuck 3, as shown in FIG. 5.

Also between the cleaning process D and the solutions filling process B is disposed a robot R4 constructed in the same way as said robots R2, R3, to perform delivery between the two processes adjacent to each other. In that case, the cleaning process D and the solutions filling process B shall preferably be disposed, though not particularly restricted, in parallel and in a direction crossing the filling line, as shown in FIG. 1, from the viewpoint of efficiency.

The conveyance of containers K from the container aligning and feed process A to the solutions filling process B is made by disposing 1 or 2 units of robot between the two processes.

Moreover, said direction control device 6, cleaning device 7 and robots R3, R4 may be omitted, depending on the shape of container or the filling process.

The solutions filling device 8 of the solutions filling process B is constructed by disposing filling nozzles 81 in such a way that the empty containers held by the chuck 3 of the robot R4 are arranged with the mouth up are moved to a position just under the filling nozzles 81 and that the filling nozzles 81 are inserted in the empty container when the chuck 3 goes up next time, and connecting the respective filling nozzles 81 to a solutions filling pump system 83 through a solutions injection tube 82.

Also on this solutions filling device 8, the filling nozzles 81 disposed at a higher position are inserted in the empty containers held by the chuck 3 of the robot R4, and this state is checked by means of a sensor, etc., so as to feed a certain quantity (of solutions) into the empty containers with a predetermined filling pattern through the solutions injection tube 82, by driving the solutions filling pump system 83, in the same way as with the cleaning device 7.

When injecting a solution in empty containers in this way, it is necessary to make the filling in a way not to cause foaming of the filled solution solution. Once foaming takes place by dragging air into the solution solution to be filled in the container, the foam does not easily disappear because of viscosity of the solution, etc. and this makes it difficult to check for penetration of foreign matters. To prevent such foaming at the time of filling of a solution solution, the container posture and distance is controlled so that the liquid level may keep a distance, against the fixed filling nozzles 81, not causing any foaming at the time of filling from the filling nozzles 81 depending on the velocity of filling of solution solution in the containers, while maintaining the best posture for the containers. For that purpose, the chuck 3 of the robot R4 is swung, to make the tip of the filling nozzles 81 get in touch with or come close to the inner face of the containers and the filling nozzles 81 and lower the chuck 3 depending on the volume of solution solution filled in the empty containers by the filling nozzles 81. This state is given in FIG. 8.

Furthermore, it is so arranged that the actions of the chuck 3 of the robot R4 may be adjusted easily, with a change of the program controlling the robot R4, in the case where the actions are made according to the type of the container used or of the solution solution to be filled.

To detect correct execution of this filling of solution solution into the container, a filled volume detecting means is provided.

For this filled volume detecting means, differential transformer type measuring device is adopted, to enable measurement for the respective containers individually and at a time. This detection consists in measuring the container in empty state with a tare measuring device 73 at a position immediately before the solution filling process (B), saving it in memory, recalculating it with a filling measuring device 74 after filling of the solution solution, and judging the difference between the two, to accept products in the revised range of allowance as non defective and reject products out of this range as defective. Such defective product has its measured value by the filling measuring device 74 memorized, and is discharged when it moves to the defective product discharging process F.

By executing this series of operations with an articulated robot, it becomes unnecessary to use any conveying system of complicated mechanism and, thanks to treatment by articulated robot provided with a chuck 3, adaptation to change of container shape, etc. can be made with replacement of this chuck and change of program only.

After the solution solution is filled into the empty container, a cap is installed on this filled container in the plugging process C. The plugging in this plugging process C is made, though not particularly restricted, by either pressure fitting the cap to the container with the plugging device 9 or screw the cap into the container by turning it.

This plugging device 9 is composed, as shown in FIG. 4, of a container chucking base 91 on which to place the container filled with solution solution by the robot R5 or the robot R6 in the case where no inner cap is used, received in the state held by the robot R5 or the robot R6, a cap feeder 92 for aligning caps in a line and feeding them one by one, a cap aligning robot R10 for feeding one by one the caps delivered from the cap feeder 92 in a line to the cap aligning tray 93, and a cap feed & container take-out robot R8 designed in a way to receive aligned caps from the cap aligning tray 93, hold and put the caps from above the containers supported by the container chucking base 91 and plug them with slewing.

This container chucking base 91 is provided with a chuck 94 for receiving all the empty containers fed by either the robot R5 or the robot R6 and supporting them, and this chuck 94 is designed to come to prescribed position for plugging all the empty containers after receiving and holding them.

With this construction, the top end face of the empty container at the lower position of the chuck 94 becomes lower than the cap, held and put forward by the chuck 3 of the cap feed & container take-out robot R8, and the respective empty containers by the chuck 94 and the respective caps held by the chuck of the robot R8 face each other vertically, and plugging is made automatically by lowering and slewing the chuck 3 holding the cap, while holding the empty containers with the chuck 94.

And, after the plugging, the chuck 3 of the robot R8 is made to retreat from the position over the chuck 94 of the container chucking base 91, and the containers plugged with lifting of the chuck 94 of the container chucking base 91 is made to go up. After that, the chuck 3 of the robot R8 is made to advance again, to hold the plugged containers at the shell part, and feed them to a weighing device 95 by slewing the robot R8.

The cap feeder 92 is a parts feeder constructed in a way to make the caps introduced in a hopper move, by giving vibrations to the caps in the hopper, along the inner circumferential face of the hopper toward the exhaust port side in a line while vibrating, and the caps are grasped one by one by the chuck 3 of the robot R10, and transferred in a line onto the cap aligning tray 93. In that case, the caps held by the robot R10 are adjusted in orientation.

The cap aligning tray 93, disposed in a way to move forward and backward between the space in front of the cap aligning robot R10 and the space in front of the cap feed & container take-out robot R8, moves to the space in front of the cap feed & container take-out robot R8 when a prescribed number or 10 pieces, for example, of caps fed from the cap feeder 92 by the cap aligning robot R10 are aligned on the cap aligning tray 93, the caps being retained by the chuck 3 of the robot R8, and moves back to the initial space in front of the cap aligning robot R10 when the cap aligning tray 93 becomes empty, to receive a supply of next caps, and repeats this motion.

Still more, there are cases where the containers are provided with inner cap, depending on the type and use, etc. of the solution solution to be filled in the containers. In such a case, an inner cap plugging process E is provided between the solutions filling device 8 and the plugging device 9 of the filling line. And, it is so arranged that empty containers are handed by the robot R4 directly to the chuck 3 of the robot R5, and fed from this robot R5 to the internal plugging device (10). This inner cap plugging process E is performed mainly by an internal plugging device 10, and this internal plugging device 10 is composed of a container receiving base 11 for supporting aligned empty containers placed on it, an inner cap feeder 12 for aligning and feeding inner caps, a robot R7 for feeding one by one the inner caps delivered from the inner cap feeder 12 in a line to the inner cap aligning tray 13, and an inner cap feed & container take-out robot R6 for receiving aligned inner caps from the inner cap aligning tray 13 and putting the inner caps on the containers supported by the chuck 14 on the container receiving base 11 and taking them out.

This inner cap feeder 12, which is an ordinary parts feeder, is constructed in a way to align the inner caps introduced in a hopper, by giving vibrations to the inner caps in the hopper, along the inner circumferential face of the hopper toward and lead them out in a line, to thereby hold the inner caps one by one with the chuck 3 of the robot R7, and transfer them onto the inner cap aligning tray 13 by adjusting the orientation of the respective inner caps. In that case, the inner caps are disposed in a line so as to agree with the pitch of the empty containers aligned on the container receiving base 11.

This inner cap aligning tray 13 is disposed in a way to move forward and backward between the space in front of the inner cap aligning robot R7 and the space in front of the inner cap feed & container take-out robot R6, and it is arranged that the chuck 3 of the robot R6 is extended, when the inner cap aligning tray 13 on which are aligned the inner caps in front of the robot R7 comes to the space in front of the robot R6, to receive and hold the inner caps from the inner cap aligning tray 13 with the chuck 3.

This inner cap feed & container take-out robot R6 is designed to make the inner caps advance in the held state, and put them down, at a position over the containers held by the chuck 14, on the container receiving base 11 to attach the inner caps to the respective containers, and hold the containers plugged with inner caps at the shell part with the chuck 3, to move the containers to the subsequent plugging process.

The chuck 3 installed on said robots R1˜R10 and the robot R11, constructed as shown in FIG. 5, is designed not to act independently for the respective chucking claws 4 but to make a holding or releasing action simultaneously for all the chucking claws with a single signal, for the sake of simplification of the circuit and the apparatus.

Yet more, of the containers held by the chuck (3), those which are defective, if any, in either cap or inner cap, etc. are judged as defective, and only the defective containers are discharged to either the defective cap or inner cap rejecting unit F1 with the robot R6.

The plugged containers placed on the weighing device 95 by the robot R8 are submitted to detection of filling volume by the weighing device 95 and to verification of presence or not of cap, etc. by a cap sensor 96 installed on the weighing device 95, and only the plugged non defective goods are delivered to the non defective goods receiving robot R11 installed outside, through the outlet hole 0 of the clean room with the robot R9.

In that case, unplugged containers and defective goods with filling error, etc. are received together with non defective goods by the robot R9 from the weighing device 95 and, after all these goods moved to either the unplugged defective good eliminating unit F2 or the filling error eliminating unit F3 of the unplugged defective good eliminating process F installed in the clean room, only the defective goods are eliminated, while the non defective goods are discharged through the outlet hole O of the clean room.

The elimination of these defective goods is made, when the chuck 3 of either the robot R6 or the robot R9 came to the position of the defective cap or inner cap rejecting unit F1, the unplugged defective good eliminating unit F2 or the filling error eliminating unit F3, below this chuck 3 and by means of a defective good eliminating devices 97 disposed at the same pitch as that of the respective chucking claws 4. This defective good eliminating devices 97 incorporates wedge-shaped claw opening cones 97a at the same pitch with the chucking claws 4 and, when air is supplied to the cylinder 97b at the bottom disposed on the claw opening cone 97a which is the portion to get in contact with defective goods, at a shift signal from the previous process, opens the container in a way to push and expand the chucking claw 4 with a rise of this claw opening cone 97a, so as to discharge defective goods only.

Only the non defective goods left after thus eliminating defective goods are carried to the outlet of the clean room with slewing of the robot R9, delivered to the non defective goods receiving robot R11 disposed outside the clean room, and transferred by releasing the chuck of the robot R11, on the non defective goods conveyor C3.

In a solutions manufacturing workshop where germ-free operations are requested, the static pressure of the air in the room is kept high and the air is made to flow in the direction of the general packaging room in a semi-germ-free state or not requiring any sterilization outside the clean room, to maintain the filling chamber in a germ-free state. Although light containers, etc. are blown off by wind in many cases at the border section with a high differential static pressure between chambers, such problem can be solved by making the delivery with a robot as in the present invention.

Moreover, to perform filling of solutions with high accuracy, inspection or measurement are made about presence or not of impurities or air bubbles in the container, weight of solutions volume to be filled in the container, liquid level position, plugging situation and direction of inner cap, plugging or not with cap, etc.

The above (robots) make predetermined specialized actions respectively, and all those robots are programmed to be driven in synchronized way, so that the filling work into the containers may flow continuously. The robots R2˜R6 disposed between the respective processes are constructed in a way to slew by approximately 180, to enable smooth movement of empty containers or containers filled with solutions and plugged between the previous process and the subsequent process, by shortening the moving line, and the equipment units of the respective processes or empty container feed process A, cleaning process D, solutions filling process B, inner cap plugging process E, and plugging process C are disposed in the direction crossing, in the direction intersecting orthogonally, for example, the flow of the conveying & filling line, to promote reduction of size of the clean room in which to install this filling line.

Furthermore, the present invention, which has so far been explained about solution solution as material to be filled in the containers, may also be used for filling such liquids as cosmetics, perfume, etc., viscous liquids, powder, etc. in the same way as solutions.

Explanation has so far been made on the solution filling and plugging system to a container according to the present invention, based on an embodiment, but the present invention is not restricted to the construction described in said embodiment, and can be changed in construction as required to the extent not deviating from the essential purpose of the invention, such as omission of respective processes in said embodiment or addition of other processes, etc.

1. A solution filling and plugging system to a container characterized in that it is comprised of at least a container alignment and feed process, a solution filling and plugging process, performs delivery of containers between the respective processes with a robot disposed between the respective processes and controls the posture of the robot for retaining and delivering the container, by means of a programmed control according to the shape, etc. of the containers, so as to carry the containers one after another without being influenced by container shape.

2. A solution filling and plugging system to a container as defined in claim 1, wherein an articulated robot is used.

3. A solution filling and plugging system to a container as defined in claim 1, wherein a chuck retaining the containers depending on container shape is replaceably disposed on the robot.

4. A solution filling and plugging system to a container as defined in claim 1, wherein, in the solution filling process, the container holding posture is controllable so that the container may take an optimal posture against the filling nozzle.

5. A solution filling and plugging system to a container as defined in claim 1, wherein, between the container alignment and feed process and solution filling process, is provided a container direction change process for detecting the direction of containers and forcing them to travel in a unified direction.

6. A solution filling and plugging system to a container as defined in claim 1, wherein a container cleaning process is provided before the solution filling process.

7. A solution filling and plugging system to a container as defined in claim 6, wherein, in the container cleaning process, the container holding posture is controllable so that the container may take an optimal posture against the cleaning nozzle.

8. A solution filling and plugging system to a container as defined in claim 1, wherein, between the solution filling and plugging processes is provided an inner cap plugging process for forcing inner caps to travel in a unified direction.
